(19) United States
(12) Patent Application Publication
(10) Pub. No.: US 2024/0329946 A1
(43) Pub. Date: Oct. 3, 2024

(54) APPLICATION CONFIGURATOR SYSTEMS AND METHODS THEREOF

(71) Applicant: THEMATHCOMPANY. INC, Chicago, IL (US)

(72) Inventors: Harshad Praveen MULEY, Chicago, IL (US); Shridhar GUNTURY, Chicago, IL (US); Srivatsa KANCHIBOTLA, Chicago, IL (US); Lalatendu SAHU, Gopalpur (IN); Mridula VASUDEVAMURTHY, Bangalore (IN); Subhasis DEBSHARMA, West Bengal (IN); Anoop S, Bangalore (IN); Manjunath Narasimha MURTHY, Bangalore (IN); Ragul Ravi R, Chennai (IN); Radhakrishna SAMAD, Sundargarh (IN); Subarna DEY, Kolkata (IN); Preeti Kanchan SORENG, Bangalore (IN); Ira SHRIVASTAVA, Jabalpur (IN); Sameena SHAIK, Secunderabad (IN); Samuel JOHNSON, Bangalore (IN); Biswajeet MISHRA, Ganjam (IN)

(73) Assignee: THEMATHCOMPANY. INC, Chicago, IL (US)

(21) Appl. No.: 18/623,771

(22) Filed: Apr. 1, 2024

(30) Foreign Application Priority Data
Mar. 31, 2023 (IN) 202341024964

(51) Int. Cl. G06F 8/38; G06F 8/34; G06F 11/36; G06T 11/20

(52) U.S. Cl. CPC G06F 8/38; G06F 8/34; G06F 11/3664; G06F 11/3696; G06T 11/206

(57) ABSTRACT

Embodiments disclosed herein relate to application configurator systems and methods thereof. The embodiments herein disclose building and testing data products that are responsive, interactive, and custom user interface elements contextualized to at least one application implemented in the execution environment based a user's requirement. Further the embodiments herein disclose display an interactive functional dashboard to perform at least one function on at least one application presented in the application configurator, The embodiments herein provide the ability to copy the application and its contents from one environment to another. The embodiment herein is to enable multiple users to access and edit the applications simultaneously.

### TECHNICAL FIELD

Embodiments disclosed herein relate to the field of application configurators. More particularly it relates to application configurator systems and methods thereof.

### BACKGROUND

Currently, insights generated in the data analysis can be useful when it is consumed by the intended business user to make decisions and benefit the business. For consumption to happen, insights must be represented visually through an application to the business user. Current technologies offer simplistic dashboards which can depict basic analysis but are not highly interactive as an application would be. This greatly reduces the ability of the user to consume insights.

The outputs of data science techniques vary greatly and many different visual depictions (graphs, tables, simulators, planograms, etc.) are needed to convey information to the business user. Existing visual tools are limited in the options that they offer for data depiction.

Also, information overload/cognitive overload prevents the user from being able to absorb relevant information and make effective decisions. This is rectified with recommended screen layouts.

Building applications from scratch can take anywhere between three to six months depending on the complexity of the application. Due to this, clients may choose not to use applications and hence lose out on the consumption of analytics outputs. Also, the ability to visualize models, insights, and dynamic interactions between data representations is not possible through standard visualization tools available in the market. Therefore, explainable AI/ML models and interaction with models are not possible through standard visualization tools.

### OBJECTS

The principal object of the embodiments herein is to disclose to application configurator systems and methods thereof.

Another object of the embodiment herein is to set up independent execution environments for configuring applications that may improve user experience in terms of loading time and computational capacity of the application.

Another object of the embodiment herein is to provide the ability to copy the application and its contents from one environment to another.

The further object of the embodiment herein is to enable multiple users to access and edit the applications simultaneously.

Another object of the embodiment herein is to access an execution environment associated with an application configurator,

Another object of the embodiment herein is to build and test data products that are responsive, interactive, and custom user interface elements contextualized to at least one application implemented in the execution environment based a user's requirement.

Another object of the embodiment herein is to cause to display an interactive functional dashboard to perform at least one function on at least one application presented in the application configurator,

Another object of the embodiment herein is to modify interactive screen, modify layouts, modify modules, modify widgets, modify metrics and modify filters;

Another object of the embodiment herein is to allow the application configurator to build and test data products without having a dependency on external tools or packages; and wherein there is no requirement of expertise in UI development frameworks and libraries.

Another object of the embodiment herein is to modify at least one of screens, layouts, widgets, metrics and filters are modified using a user interface as code (UIaC) and modules, wherein modules enables to toggle specific one function on at least one application presented in the application configurator.

Another object of the embodiment herein is to allow to insert modules that enable the user to insert the configurations with specific information and no information required functions.

Another object of the embodiment herein is to modify screens comprises adding, removing, previewing, and resetting, screens and sub screens at different hierarchy levels.

Another object of the embodiment herein is to modify interactive screen, modify layouts, modify modules, modify widgets, modify metrics and modify filters at each level of hierarchy of the screen.

Another object of the embodiment herein is to manage at least one function comprises performing at least one of adding, removing, previewing, saving, testing and resetting the at least one of interface elements.

Another object of the embodiment herein is to store the application configurations of the application implemented in the execution environment comprising a description, a problem area, an execution environment, a login, and application logos in the application configurator metadata database.

Another object of the embodiment herein is to compose at least one of hierarchical filters, non-hierarchical filters, single select filter, multi-select filters, date filters, and number range filters are composed using a filter UIaC.

Another object of the embodiment herein is to configure report widgets comprising at least one of numeric metrics, graphs, and charts depending on the widget type.

### SUMMARY

An embodiment disclosed herein related to an application configurator system comprising a processor; a memory. The processor is coupled with the memory and wherein the processor is configured to receive a selection input for accessing an execution environment associated with an application configurator, wherein the application configurator is a system that allows to build and test data products that are responsive, interactive, and custom user interface elements contextualized to at least one application implemented in the execution environment based a user's requirement; cause to display an interactive functional dashboard to perform at least one function on at least one application presented in the application configurator, wherein the at least one function comprises at least one of modify interactive screen, modify layouts, modify modules, modify widgets, modify metrics and modify filters; manage the at least one function based on a user input.

An embodiment disclosed herein related to a A method comprising: receiving a selection input for accessing an execution environment associated with an application configurator, wherein the application configurator is a system that allows to build and test data products that are responsive, interactive, and custom user interface elements contextualized to at least one application implemented in the execution environment based a user's requirement; causing to display an interactive functional dashboard to perform at least one function on at least one application presented in the application configurator, wherein the at least one function comprises at least one of modify interactive screen, modify layouts, modify modules, modify widgets, modify metrics and modify filters; managing the at least one function based on a user input.

### BRIEF DESCRIPTION OF FIGURES

The embodiments disclosed herein are illustrated in the accompanying drawings, throughout which like reference letters indicate corresponding parts in the various figures. The embodiments herein will be better understood from the following description regarding the drawings, in which:

FIG. 1 is an example diagram illustrating a flowchart for creating a new application configurator setup, according to embodiments as disclosed herein;

FIG. 2 illustrates a system (200) block diagram for the application configurator system (200), according to embodiments as disclosed herein;

FIG. 3 is an example diagram illustrating the homepage of the application with various sectors, according to embodiments as disclosed herein;

FIG. 4 is an example diagram illustrating the created application for strategy and planning function, according to embodiments as disclosed herein;

FIG. 5 is an example diagram illustrating the view application for different users, according to embodiments as disclosed herein;

FIG. 6 is an example diagram illustrating the various modules or features of the created application, according to embodiments as disclosed herein;

FIG. 7 is an example diagram illustrating the performance of the created application, according to embodiments as disclosed herein;

FIG. 8 is an example diagram illustrating the preview screen of the application, according to embodiments as disclosed herein;

FIG. 9 is an example diagram illustrating various layouts used for creating the application, according to embodiments as disclosed herein;

FIG. 10 is an example diagram illustrating the application managing feature using various aspects, according to embodiments as disclosed herein;

FIG. 11 is an example diagram illustrating manage modules features for updating the application, according to embodiments as disclosed herein;

FIG. 12 is an example diagram depicting the implementation of the user interface within the platform, according to embodiments as disclosed herein;

FIG. 13 is an example diagram depicting the implementation of the widget component, according to embodiments as disclosed herein;

FIG. 14 is an example diagram depicting the implementation of the screen-level action within the platform, according to embodiments as disclosed herein;

FIG. 15 is an example diagram depicting the implementation and saving of the screen-level action, according to embodiments as disclosed herein;

FIG. 16 is an example diagram depicting the layout selection feature, according to embodiments as disclosed herein;

FIG. 17 is an example diagram depicting the visual user interface management, according to embodiments as disclosed herein;

FIG. 18 is an example diagram depicting the implementation of the visual user interface feature, according to embodiments as disclosed herein; and

FIG. 19 is an example diagram depicting the implementation of the application replication to be created from the preview version, according to embodiments as disclosed herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

For the purposes of interpreting this specification, the definitions (as defined herein) will apply and whenever appropriate the terms used in singular will also include the plural and vice versa. It is to be understood that the terminology used herein is for the purposes of describing particular embodiments only and is not intended to be limiting. The terms “comprising”, “having” and “including” are to be construed as open-ended terms unless otherwise noted.

The words/phrases “exemplary”, “example”, “illustration”, “in an instance”, “and the like”, “and so on”, “etc.”, “etcetera”, “e.g.,”, “i.e.,” are merely used herein to mean “serving as an example, instance, or illustration.” Any embodiment or implementation of the present subject matter described herein using the words/phrases “exemplary”, “example”, “illustration”, “in an instance”, “and the like”, “and so on”, “etc.”, “etcetera”, “e.g.,”, “i.e.,” is not necessarily to be construed as preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

It should be noted that elements in the drawings are illustrated for the purposes of this description and case of understanding and may not have necessarily been drawn to scale. For example, the flowcharts/sequence diagrams illustrate the method in terms of the steps required for understanding of aspects of the embodiments as disclosed herein. Furthermore, in terms of the construction of the device, one or more components of the device may have been represented in the drawings by conventional symbols, and the drawings may show only those specific details that are pertinent to understanding the present embodiments so as not to obscure the drawings with details that will be readily apparent to those of ordinary skill in the art having the benefit of the description herein. Furthermore, in terms of the system (200), one or more components/modules which comprise the system (200) may have been represented in the drawings by conventional symbols, and the drawings may show only those specific details that are pertinent to understanding the present embodiments so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the present disclosure should be construed to extend to any modifications, equivalents, and substitutes in addition to those which are particularly set out in the accompanying drawings and the corresponding description. Usage of words such as first, second, third etc., to describe components/elements/steps is for the purposes of this description and should not be construed as sequential ordering/placement/occurrence unless specified otherwise.

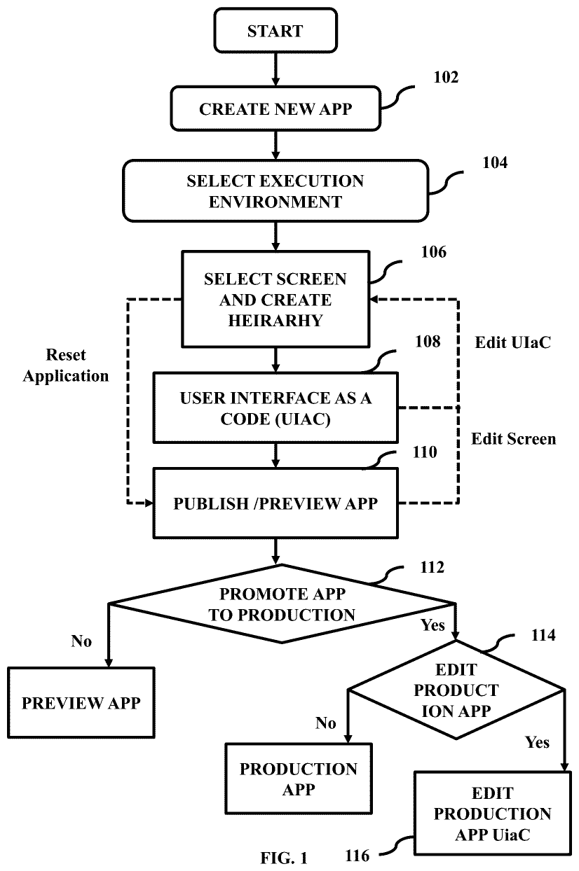

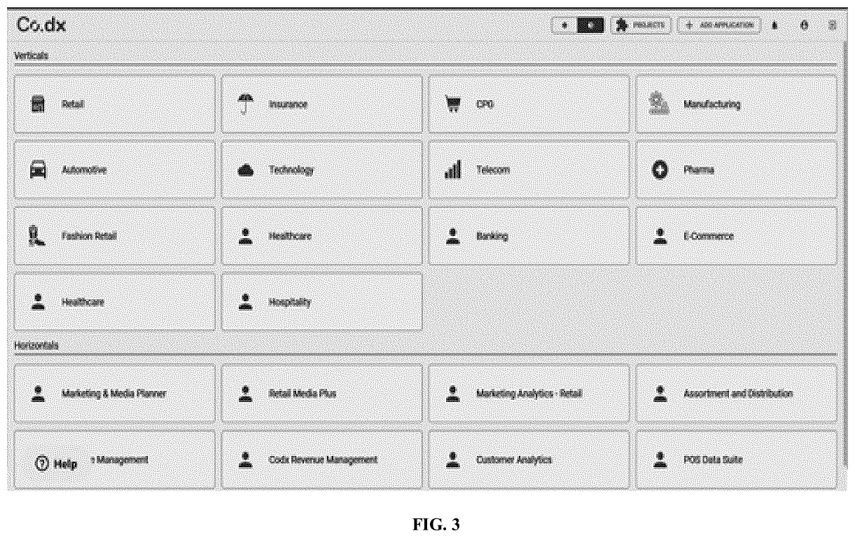

The embodiments herein achieve an application configurator system (200) and methods thereof. Referring now to the drawings, and more particularly to FIGS. 1 through 19, where similar reference characters denote corresponding features consistently throughout the figures, there are shown embodiments.

The various actions in method 100 may be performed in the order presented, in a different order or simultaneously. Further, in some embodiments, some actions listed in FIG. 1 may be omitted.

FIG. 1 is an example diagram illustrating a flowchart for creating a new application configurator setup, according to embodiments as disclosed herein. As illustrated in FIG. 1, users such as data scientists can use a new application configurator to create a new application through the user interface. It helps to build front-end applications with different application configurators. New Application Configurator is a capability that allows one to build and test applications on the platform without having a dependency on external tools or packages. New Application Configurator enables to use of the sample codes which optimizes the performance.

In an embodiment herein, at step 102, the new application configurator receives a request to create a new application. A user may select the type of application, entering application details type of industry and alike through a user interface. Functions for the selected application can be selected appropriately. The appropriate details for the application can be provided and saved, which can be edited later. Thus, by providing details, the application can automatically map to the selected industry.

At step 104, the application configurator promotes the ability to customize the application from one version to another required version. The application configurator supports several numbers of execution environments such as preview App, staging environment, production environment etc. The user may select at least one of the execution environments to work upon.

At step 106, in the Screens section, the user may design new screens, sub-screens, and sub-tabs. The application configurator enables the user to configure screens with multiple levels of hierarchy. The recommended level to configure the screens is the lowest level of hierarchy. The application configurator provides that flexibility to divide the application into different sections, sub-sections, and tabs at any point of time.

The embodiments herein, at step 108, allow the creation of custom data products, contextualized to the client's businesses through a large library of UI widgets. The UI widgets are powered by custom python codes, which refer to as User Interface as Code (UIaC). These UIaCs enables a user for e.g. a data scientist to build responsive, interactive, and custom UI elements through a python interface, without any prior expertise in UI development frameworks and libraries (such as HTML, CSS, JavaScript, react, etc.). The App configurator's UIaC feature in combination with its rich UI widget library help in building interactive and responsive user interfaces, for businesses to consume data and model insights.

In an embodiment herein, once the screens, hierarchy, filters are defined, at step 110, the user may preview the application using the preview version hyperlink in the application screen.

In an embodiment herein, after viewing the preview of the application, at step 112, the application configurator may promote the application to the production environment, upon receiving production approval from the user.

In an embodiment herein, at step 114, the user may be enabled to edit the application in the production environment. At step 116, the user may also edit the application using UIaC.

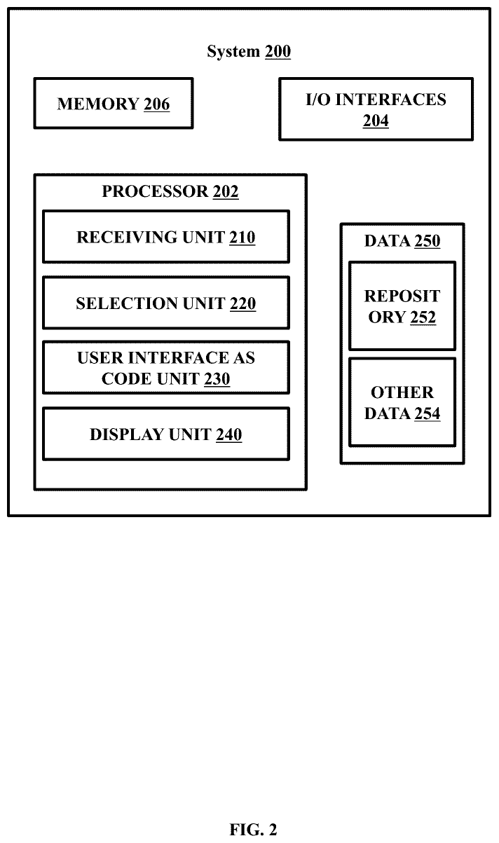

FIG. 2A illustrates a block diagram of the virtual newsroom system (200), according to one or more embodiments. The system (200) disclosed herein comprises: a memory (206), a processor (202), and Input Output (I/O) interfaces (204) The processor (202) is communicatively coupled to the memory (206), and Input Output (I/O) interfaces (204). The system (200) also comprises data 250. The processor (202) may take the form of a single core processor, multi-core processor (e.g., a dual core processor, triple core processor, quad core processor, etc.), microprocessor, etc. In some embodiments, the processor (202) may be external to an apparatus (e.g., server), for example the processor (202) may be a remote processor (e.g., a cloud-based processor). Alternatively, or additionally, the processor (202) may be internal and/or local to the apparatus. The system (200) further comprises: a receiving unit (210), a selection unit (220), a user interface as code unit (230), and a display unit (240).

The data (250) may include a repository (252) for storing data processed, computed, received, and generated by one or more of the units. Furthermore, the data (250) may include other data (254) for storing data generated as a result of the execution of units than the ones mentioned above. The data (250) may comprise all the databases as mentioned hereinafter in the specification description.

The embodiments disclosed herein can be implemented through at least one software program running on at least one hardware device and performing network management functions to control the network elements. The network elements shown in FIG. 2 include blocks which can be at least one of a hardware device, or a combination of hardware device and software module.

All the steps disclosed above are explained in detail along with examples below.

In an embodiment herein, the app creation unit may receive an input from the user interface to create a new application. Along with the new app creation request, it also may receive the application details and the industry for which the application is generated.

FIG. 2 is an example diagram illustrating the homepage on the user interface of the application configurator with various sectors, according to embodiments as disclosed herein. As illustrated in FIG. 2, the homepage of the application can be accessed using a web link on the user interface. For provide input to the app configurator, the user interface receives input for creating a new application through a button to create a new application. Upon receiving the request for creating a new application an Add Application window is displayed on an interactive display, to receive the application details, and a selection of the sector/industry for creating the application from the user through the interactive display.

In an embodiment herein, functions for the selected application can be selected appropriately from the Application window on the user interface. The appropriate details for the application can be provided and saved, which can be edited later. Thus, by providing application details and the selection of the industry, the system (200) may automatically map to the selected industry. Therefore, on saving the application details, the system (200) can create an application and display the notification with “Application added successfully”. The user can navigate back to the homepage of the application configurator display. The interactive display may have an industry tab for which the application is generated. For an instance, when the user interacts with the industry tab, and the system (200) displays a functional dashboard screen. In an embodiment herein, the system (200) displays the created application against the selected function and industry on the function dashboard screen.

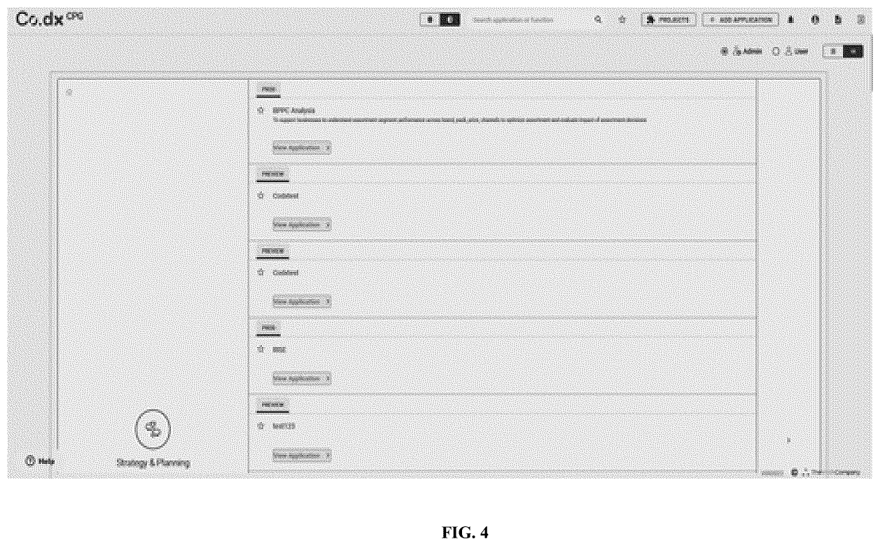

FIG. 4 is an example diagram illustrating the created application for strategy and planning function, according to embodiments as disclosed herein. As illustrated in FIG. 4, the application is created for strategy and planning function within the consumer-packaged goods (CPG) industry. So, in the function dashboard screen, the system (200) may display the application for strategy and planning functions within the CPG industry as illustrated in FIG. 4.

In an embodiment herein, the system (200) provides various viewing modes on the display, that a user may select. The viewing modes may include but is not limited to admin mode, staging mode, preview mode, and production mode. The system (200) may receive an appropriate selection of the viewing mode through radio buttons. On receiving selection of admin mode, the user may be able to access both the preview and production version of the application. For admin mode, the preview version of the created application can be copied to the production version. By doing so the user may be able to view the created application under the production version tab of the function dashboard screen. For an instance, on selecting admin mode, the application is displayed as a preview version. Therefore, in admin mode, the created application may be copied to the production version. Hence, the system (200) may display the created application under the preview version tab of the function dashboard screen. On selecting the User mode, the user can access only the production version of the application created on the functional dashboard screen.

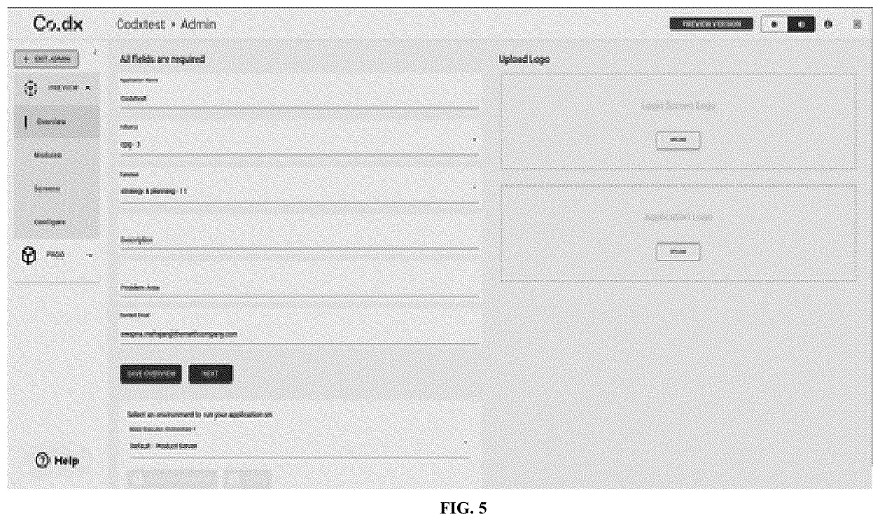

FIG. 5 is an example diagram illustrating different viewing modes for different users, according to embodiments as disclosed herein. As illustrated in FIG. 5, on receiving a request to view the application, the system (200) may display the created application page on the functional dashboard screen. Also, on the application page, for the preview mode option the system (200) may enable the user can navigate through menu options to define an overview, enable required modules, and design and configure screen layouts. Also, the Preview menu list options namely Overview, Modules, and Screens enables the user to configure the application. In the Overview section, the user can define the description, problem area, upload logos of the application. Application Name, Industry, and Function will auto-populate from the database.

In an embodiment herein, the application name, industry, and function may be displayed as defined in the add application window on the display. To change or edit the initial selections, the system (200) may receive a selection from the user from a drop-down menu and receive the selection of the appropriate industry for which the user can create an application. Function drop-down menu options will display concerning selected industry. In an embodiment herein, the system (200) may receive the description, problem area, and contact details of the user while creating the application.

In an embodiment herein, the user may upload a logo from a logo section, and select the appropriate logo to upload to the application configurator platform login page. The system (200) may display the uploaded logo on the Application page. The system (200) displays an upload logo section that allows the user to upload customized logos as per user requirements. The user may provide a selection of the Environment from the drop-down menu to run the user application. The system (200) may allow to save the entered/selected overview details.

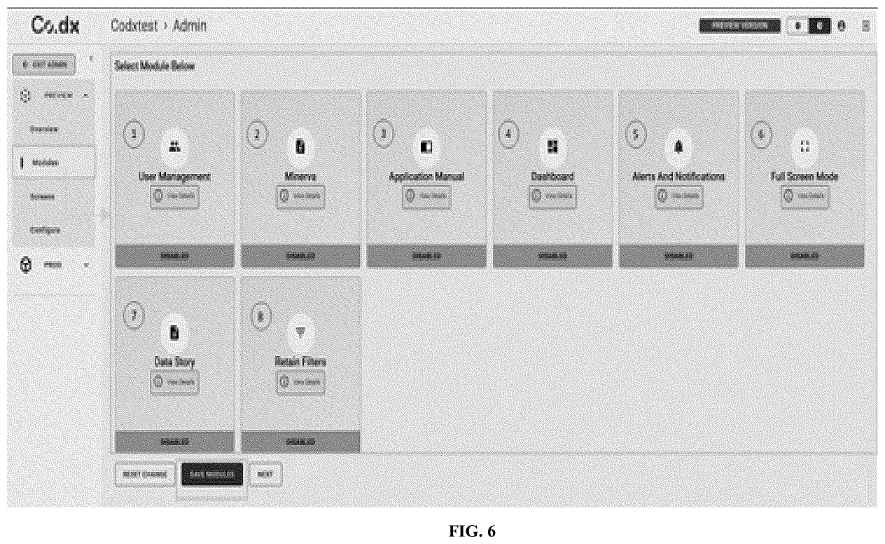

FIG. 6 is an example diagram illustrating the various modules or features of the created application, according to embodiments as disclosed herein. The system (200) may enable or disable multiple features for the application created as per the requirements. The system (200) may include different modules available in the application. The system (200) may allow the user to select the type of modules required for the application. The selected modules may be mapped and configured with the created application.

In an embodiment herein, the various modules may include a user management, an application manual, a dashboard, alerts, notifications, full-screen mode, data story, retain filters, and the like. User Management module is a feature with an app-level access module. This allows the users to control access and viewership. Enabling User Management module allows the user to select the user who can access the selected features.

In an embodiment herein, the application manual is a form of documentation that provides a business user with a guided walkthrough of the application to enable better consumption. The documentation can be in a PDF, word document, video, etc. The Dashboard is a home screen with a tile view of all the main screens of the application. It enables users to navigate across screens with ease. This can display a complete overview as defined on the screens. Alerts and Notifications features help to continually monitor active queries to look for and report on specific events or conditions. When the conditions of the alert are met, a notification is triggered. Full-screen mode feature allows users to view the screen along with the top nav bar only. The side nav bar will be collapsible. The data stories feature can allow users to share the contents of an application with a wider audience through a context-based presentation. Retain Filters feature helps the user to case the choice of the same filter selection. When a client makes a filter selection on screen 1 and moves to screen 2, the filter selection will be retained.

In an embodiment the system (200) receives the selected modules and the system (200) enables them in the application. In the screen selection unit, the system (200) may receive selection of screens. The system (200) provides the user to design new screens, sub-screens, and sub-tabs. The application configurator enables the user to configure screens with multiple levels of hierarchy. It is recommended to configure the screens with the lowest level of hierarchy. The application configurator provides the flexibility where at any point in time, the user can divide the application into different sections, sub-sections, and tabs.

The system (200) provides screens option to configure screens to the application. The system (200) allows to add screens screen with hierarchy. The system (200) may receive the name and definition of the main screen. The user may save the created screen to the hierarchy using the user interface on the display. By default, the first screen which is added will be considered as Main Screen. To add a sub-screen to the newly added main screen, the user may enter the new screen using the Add screen tab on the interactive display. For example, the user may enter and define the new name of the sub-screen. The newly created sub-screen and the main screen may be at the same level of hierarchy. To the hierarchy, the user needs to interact with the icon with the name of the screen which the user needs to set as a sub screen. The user may select the set to sub screen option to set defining screen to sub-screen. For example, the sub-screen which is added is defined as Sub Screen1. Upon receiving the selection from the user through the selection unit, a sub screen with the selected level off hierarchy is created. Users need to select the respective screen name and select the Set to Sub Screen option to set defining screen to sub-screen. The system (200) may set the defining screen to Sub Screen differentiating the level of the hierarchy of main and sub screens.

In an embodiment herein, upon the user selecting the Set to Tab option, the system (200) will set the defining screen to a tab differentiating the level of the hierarchy of main, sub screens, and tabs. The system (200) may prompt the user to save the defined level of the hierarchy of screens. The system (200) may enable screen settings on the functional dashboard to open and configure the respective screens. It is recommended to start configuring screens from the lowest level of the hierarchy screens.

In FIG. 6, Tab1 is having the lowest level of hierarchy which means the main screen (Main1) is divided into sub-screens (Sub Screen 1), further dividing sub-screen (Sub Screen 1) into tab (Tab 1). The user needs to start configuring Tab1. The system (200) may prompt the user to configure the respective tab screen through receiving settings from the user.

In an embodiment herein, the application configurator provides an overview section for providing an outline of the application that describes the necessary information. In the overview section in the application configurator, the user may add an overview header, enter description wherein the user can define insights of the screen. In an embodiment herein, the system (200) also displays a link to receive feedback from a user for adding the screen in the app configurator.

In an embodiment herein, the application configurator has an option to customize the screen look. For example, under the select screen image header, the user mat selects the appropriate option to customize the look of the screen (Here, Tab1) on the home screen page and save the screen overview with the entered details in the overview section. Once the details are saved, the system (200) will display the notification that is to be displayed.

In another embodiment, filtering can be performed. Filter user interface as code (UIaC) section is provided to create filters. This section helps to add a code for creating filters. The app configurator may receive a selection of the components from Ingest Components drop-down control to ingest data from external storage/sources. The system (200) may only display the filter components in the drop-down menu. On receiving the selection of the filter components, the system (200) may display a hyperlink to view the documents. Upon receiving a selection of the hyperlink to open the widget documentation filter window. The user may get the information on the selected filter or widget from the widget document filter window. Filter or Widget is a code module with customizable parameters that user can configure. The widget document filter page may include but is not limited to a sample code to apply the filters to the screen. From the Widget Documentation-Filter page, the system (200) may copy the required sample codes. Users may choose to use the sample code exactly as it is or customize and modify the sample code as per the data requirements. The user may paste the copied sample code in Editor present in the application configurator system (200).

Once the sample code is copied, the user may change the data as required which needs to be get displayed in the application. Copying the same sample code and making changes to the data which needs to be displayed in the application enhances the performance. The system (200) may allow to test the code. The system (200) also allows view the output of the code which is tested. The system (200) allows to debug and to view the issues in the code, if any. The system (200) also performs a performance check to view the time system (200) took to run the code.

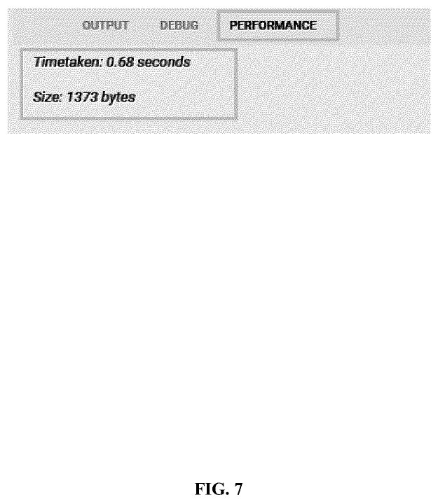

FIG. 7 is an example diagram illustrating the performance of the created application, according to embodiments as disclosed herein. As illustrated in FIG. 7, the performance and the time taken to execute are mentioned. The system (200) saves the defined details. The system (200) enables to view the preview version of the application with created filters.

In an embodiment herein, the screen-level actions enable the user to develop action feature which handles the functionality of the entire screen. The system (200) may receive a selection of the appropriate component option from the interactive screen to select the action feature. the system (200) will display the View Docs hyperlink. The user will be able to get the information on the selected action generator component/widget.

In an embodiment herein, the system (200) allows to test the application and the edited code written to apply filters to the screen. Upon receiving the test code input to test the code, system (200) will test and display the ability to test the code and generate output of the testing of the code. In an embodiment herein, the user may select to view the output. In an embodiment herein the system (200) provides a debug header to view the issues in the code, if any. In an embodiment herein, the system (200) may provide the details about the performance under the performance header, to view the time system (200) took to run the code.

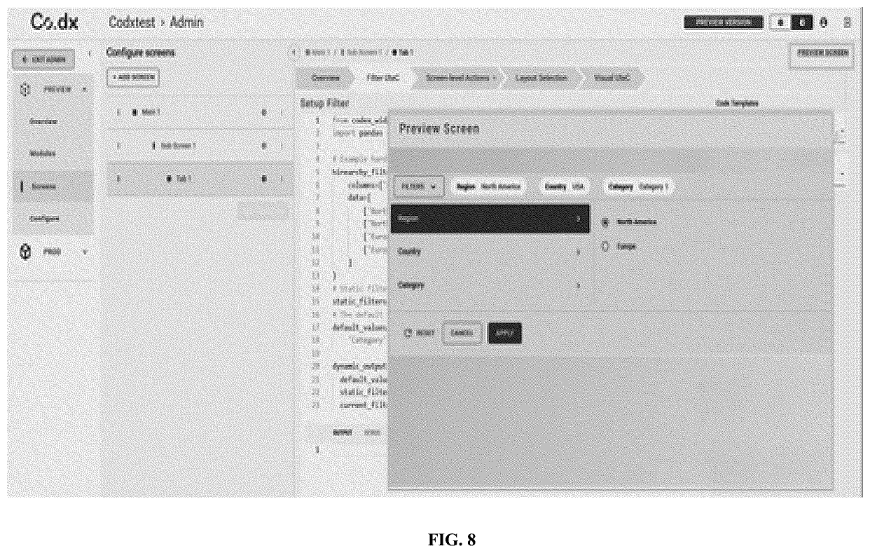

FIG. 8 is an example diagram illustrating the preview screen of the application, according to embodiments as disclosed herein. The system (200) may enable to view the preview version of the application with created filters.

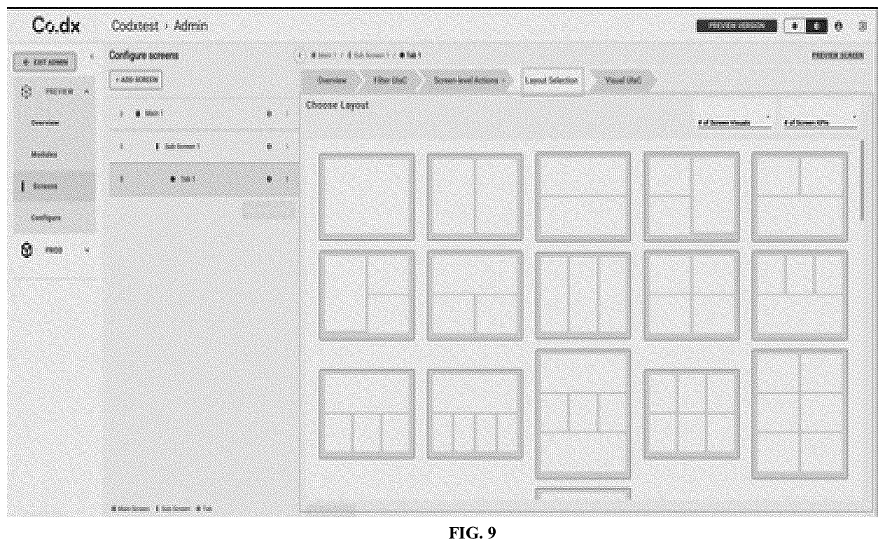

FIG. 9 is an example diagram illustrating various layouts used for creating the application, according to embodiments as disclosed herein. As illustrated in FIG. 9, layout selection enables the user to select a design from pre-set layouts enhancing the most effective use of available space. The user may select the layout from the Layout Selection tab. The system (200) may receive the selection of the type of layout, and the number of visuals to be added on the screen. The user may elect number of screen visuals from the application screen. In an embodiment herein, under the layout selection tab, the system (200) may also allow to select the number of Screen KPI's from the application screen to choose several metrics which may be displayed in the layout of the application.

For example, consider, user selects the number of screen visuals and screen KPI's as 2 and 4 respectively. Based on the selections, system (200) will display layouts. The system (200) may receive a selection of the layouts and save the selected layout. Once the layouts are saved, the system (200) may display the following notification to view the preview version of the application with the created layout. In an embodiment, the system (200) displays a hyperlink to open the preview screen.

In an embodiment herein, the visual user interface as code (UIaC) enables the user to add detailed information to the created visuals and metrics. Therefore, the system (200) provide the user interface as code to the user and receives detailed information about the visuals and metrics. The system (200) may display a Visual UIaC tab. On receiving a selection of the visual UIaC tab, the system (200) may display the selected layout by the user chose in the Layout Selection page. In the selected layout, the user may have selected the required KPI to set up the widget. On receiving the selection of the KPI/widget by the system (200), the system (200) may display the setup widget page. in the setup widget page, the system (200) may receive a defined widget setup details from the user through the functional dashboard screen. The system (200) may receive the title of the defining widget as appropriate.

The system (200) may enable a user to enter the metric factor of the defining widget as appropriate. The widget may be defined by a title and a Sub Title as appropriate. Also, the definition of the widget may have a prefix for defining widgets as appropriate. The font style of data and the font size of the data also may be altered for setting up the widget. The system (200) may receive an input to save the overview of the widget. In an embodiment herein, the system (200) may display the visual UIaC tab to define the visual components and data. A selection of the KPI or visual by the user is required to define the visual component and retrieve the data as per requirements.

In an embodiment herein, the system (200) may allow to add component to ingest data from external storage/sources. The system (200) may receive a selection of the visual components as a metric from the user interface from the screen. The system (200) may display View Docs hyperlink to open Widget Documentation-Metric window, wherein user will be able to get the information on the selected metric/widget. In an embodiment herein, the widgets and metrics added may be used as the code module with customizable parameters that user can configure. The Widget Documentation-Metric page may have a sample code that a user may edit to customize the visuals. The system (200) through the Metric page enables the user to copy the required sample codes. Users can choose to use the sample code exactly as it is or customize and modify the sample code as per the data requirements. The user may paste the copied sample code in the Editor present under the setup widget header of the visualization UIAC tab.

Once the sample code is copied, the user can change the data as required which needs to be get displayed in the application. The system (200) may receive a change in the code and display the changes accordingly in the application. Copying the sample code and making changes to the data which needs to be displayed in the application enhances the performance. The system (200) also provides testing of the widget through the test widget button to test the code. On receiving a request to test the code, the system (200) will test and display the ability to test the code. The system (200) also may display the output of the test for the user to view the output of the code which is tested. The system (200) may enable the user to debug the code to view the issues in the code, if any. The system (200) also may display the performance, to view the time system (200) took to run the code. Once the widget is edited using the change in code the system (200) may save the widget

In an embodiment herein, the system (200) may enable a preview version hyperlink to view the preview version of the application with created widgets (Here Metric 1). The system (200) may enable a user to preview the widgets. The system (200) also may enable the user to define and save the remaining KPI's, and view the saved KPIs (Here Metric 1, Metric 2, Metric 3, Metric 4. In an embodiment herein, upon previewing the widget, the system (200) enables the user to set up the visual or the widget on the selected layout. The user may define Widget Setup details in the overview option provided by the system (200) under the widget set up tab.

In an embodiment herein, the visual user interface as code (UIaC) enables the user to add detailed information to the created visuals and metrics. Therefore, the system (200) provide the user interface as code to the user and receives detailed information about the visuals and metrics. The system (200) may display a Visual UIaC tab. On receiving a selection of the visual UIaC tab, the system (200) may display the selected layout by the user chose in the Layout Selection page. In the selected layout, the user may have selected the required KPI to set up the widget. On receiving the selection of the KPI/widget by the system (200), the system (200) may display the setup widget page. in the setup widget page, the system (200) may receive a defined widget setup details from the user through the functional dashboard screen. The system (200) may receive the title of the defining widget as appropriate.

The system (200) may enable a user to enter the metric factor of the defining widget as appropriate. The widget may be defined by a title and a Sub Title as appropriate. Also, the definition of the widget may have a prefix for defining widgets as appropriate. The font style of data and the font size of the data also may be altered for setting up the widget. The system (200) may receive an input to save the overview of the widget. In an embodiment herein, the system (200) may display the visual UIaC tab to define the visual components and data. A selection of the KPI or visual by the user is required to define the visual component and retrieve the data as per requirements.

In an embodiment herein, the system (200) may allow to add component to ingest data from external storage/sources. The system (200) may receive a selection of the visual components as a metric from the user interface from the screen. The system (200) may display View Docs hyperlink to open Widget Documentation-Metric window, wherein user will be able to get the information on the selected metric/widget. In an embodiment herein, the widgets and metrics added may be used as the code module with customizable parameters that user can configure. The Widget Documentation-Metric page may have a sample code that a user may edit to customize the visuals. The system (200) through the Metric page enables the user to copy the required sample codes. Users can choose to use the sample code exactly as it is or customize and modify the sample code as per the data requirements. The user may paste the copied sample code in the Editor present under the setup widget header of the visualization UIAC tab.

Once the sample code is copied, the user can change the data as required which needs to be get displayed in the application. The system (200) may receive a change in the code and display the changes accordingly in the application. Copying the sample code and making changes to the data which needs to be displayed in the application enhances the performance. The system (200) also provides testing of the widget through the test widget button to test the code. On receiving a request to test the code, the system (200) will test and display the ability to test the code. The system (200) also may display the output of the test for the user to view the output of the code which is tested. The system (200) may enable the user to debug the code to view the issues in the code, if any. The system (200) also may display the performance, to view the time system (200) took to run the code. Once the widget is edited using the change in code the system (200) may save the widget

In an embodiment herein the system (200) comprises a configure section enables user to create a copy of versions, reset versions, and add application variables. The application configurator system (200) promotes the ability to customize the application from one version to another required version. The application configurator system (200) supports several numbers of execution environments such as Preview, Stage, Production, etc. The system (200) may receive a request to configure application variables. In Configure screen, the system (200) may receive an input through the add application variable tab to add variables to the application. The system (200) may receive the name and value of the application variable as defined by the user. The defined app variables will be saved and displayed in the display screen.

In the add application variable, under the display screen, the value of the variable will be hidden. The system (200) may receive an input to hide the value in the spread. In an embodiment herein, the system (200) may have an actions tab on the display. The actions tab may have an option to edit the application variable window. Users can view and modify the variable value, if required. The system (200) may save the updated variable value.

In an embodiment herein, the system (200) enables the user to search the required application from the system (200) database. For example, in add application variable window, in the search textbox, user can type appropriate keyword to search the required variable.

The system (200) enables configuring of production version of application. The system (200) may display the production version of the application upon receiving a selection of the production preview tab. The selection of the environment of the application may be received along with the source version of the application. The system (200) allows the user to copy the application version by choosing source version from where user wants to copy the application. The system (200) allows to preview the copied version before sending into the production environment. The system (200) may enable the user to create a new version. The system (200) will prompt a pop-up message on the display to enter the name of application for creating a new version which will be a similar name as defined in preview version. The system (200) will create a production version similar to the preview version. The system (200) will prompt to exit the admin environment to enter the production, system (200) will redirect user to a page which will be viewable by the end user.

In an embodiment herein, in case of any modifications in the application from the end user, the changes given by the user may be incorporate in preview version of the application. Once preview version of the application is finalized and conditions are satisfied, user may copy the preview version of application to production version. To copy the changes from the preview to production version for an already created application, the system (200) will allow the user to use the configure option. The system (200) may receive a selection to choose source version from where user wants to copy the application. The user may select the source version which should be copied to production version of application. The system (200) may receive an instruction to replicate the version to copy the changes from preview to production version and will be viewable to end user. In an embodiment herein, there is an option provided by the system (200) to reset version of application, upon receiving the instruction to reset the version from the user, the system (200) will reset application. This will remove all the modules, screens, configurations, and UIAC's created in the application.

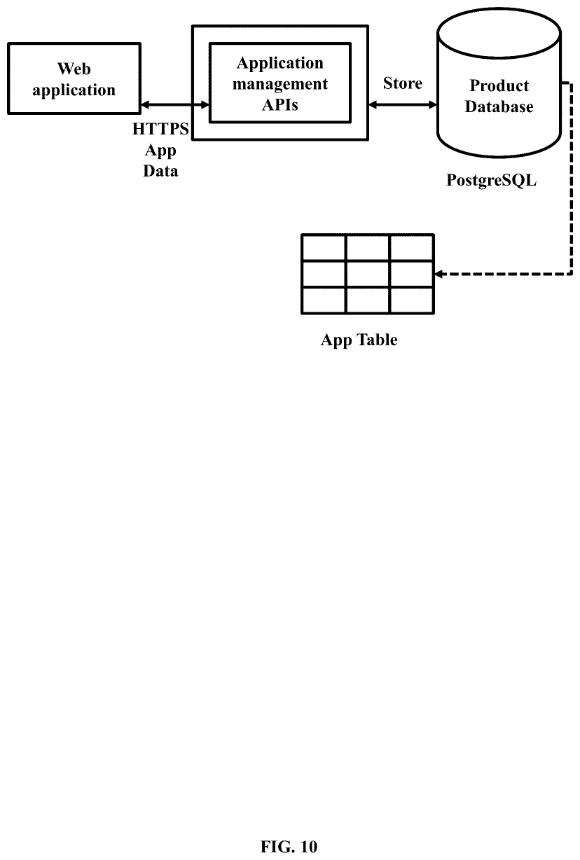

FIG. 10 is an example diagram illustrating the application managing feature using various aspects, according to embodiments as disclosed herein. The manage Application feature enables user to create application and manage the metadata related to the application. Applications can be added to a specific industry, and within which is linked to a specific function. The application configurator platform allows the user to add new groups of industries and domains and respective functions in addition to predefined domains.

In an embodiment herein, manage application feature comprises of the following capabilities but is not limited to add new application, add application metadata, update application metadata, and link application to an industry and respective function. Technical specifications of the management application feature have been illustrated in FIG. 10. As illustrated, the Web App communicates with the application configurator platform backend server via the API's exposed by the application configurator backend system (200) over a secure HTTP connection. The data between the Web Application and the application configurator backend API's is exchanged in JSON format using the appropriate HTTP method. The backend system (200) exposes API's for creating the application and for updating the metadata related to the application. All the application data will be stored within the app table of the application configurator platform PostgreSQL database.

In an embodiment herein, the create application feature enables the user to create the application with some basic application details. The backend system (200) exposes an API that accepts an HTTP POST request with JSON payload within the request body. The web application passes the basic details such as application name, email Id, industry, and function within the JSON payload. These details are stored within the app table of the application configurator platform database by the add application API. The application configurator allows user to create a new group of industries and domains and respective functions apart from predefined domains through a platform called Platform Utils. On entering the details in add application window, and upon editing and saving the details, the application will be created. Once the application is created, create app API is called which is available in app_admin.py file. The configurations set up in created application are saved in the application configurator Metadata Database.

In an embodiment herein, managing application metadata allows users to store the data of the application in the application configurator Metadata Database. The metadata of the application can be updated using the application overview API exposed by the backend system (200). The application configurations listed under the overview section namely description, problem area, execution environment, customized login, and application logos, etc. are stored in the application configurator Metadata Database. The application overview API accepts an HTTP POST request and expects JSON payload in its request body. The data is then updated within the app table of the application configurator platform database.

In an embodiment herein, modules enable application administrators to toggle specific functionalities within the application. In an embodiment herein, the application configurator allows user to insert several modules, some of which require writing additional code and some of which do not. Modules are one of the significant features that enable the user to insert the configurations with code and no code-required functionalities. The modules that are not required to write additional code are User Manual, Minerva, Application Manual, Dashboard, and Data Story. The modules that are required to write additional code are Retain Filters Alerts & Notifications.

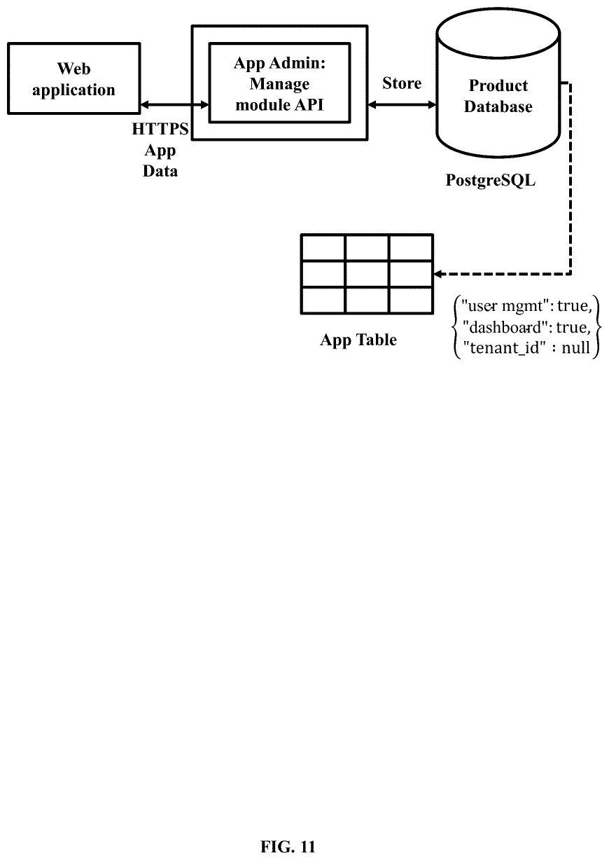

FIG. 11 is an example diagram illustrating manage module features for updating the application, according to embodiments as disclosed herein. As illustrated in FIG. 11, the application configurator backend provides an API for updating the application modules that need to be enabled within the application. Manage module API captures the modules that need to be toggled for the application from the web application. API uses the application ID passed as the route parameter to determine the application for which the modules need to be toggled. The data is a JSON object and consists of Boolean values which represent if a specific module needs to be enabled or disabled. The data in JSON format is converted into string or varchar and then stored with the app table within the product database.

TABLE 1

| Field Name | Data Type | Description |
|---|---|---|
| user_mgmt | Boolean | Toggle User |
| | | Management Module |
| Alerts | Boolean | |
| dashboard | | |
| Minerva | Object | Minerva module details |
| | | with enabled flag and |
| | | tenant id |
| retain_filters | Boolean | |
| user_mgmt_app_screen_level | Int | Screen access level, |
| | | ranges from 1-2 |
| Full_screen_mode | Boolean | |
| data_story | Boolean | Toggle Data Story |
| | | Module |

Table 1 displays the modules with the data type and description that may be stored in the database. API Specifications for Manage Modules are listed below in Table 2

TABLE 2

| | | | Request/ | |
|---|---|---|---|---|
| | | | Response | |
| | | HTTP | Content | Authorization |
| Name | Description | Method | type | required |
| Manage | API to toggle | PATCH | JSON | Yes |
| Application | required modules on | | | |
| modules | Application | | | |

In an embodiment herein, the manage Screen feature of the Application configurator provides the application admins with the capability to manage the application screen and its layouts. This also allows the user to define the User Interface code for each of the widgets on the screen. Additionally, filters can be configured with the application screen for all the widgets. To add a screen to the application, the system (200) may display an screen tab, and provide a name to the screen. The user may be prompted to save the defined screen. Once the screen name is saved, save_screen_config API is called which is available in the app_admin.py file. The defined screen set up in created application is saved in the application configurator Metadata Database.

In another embodiment, management of application screens and their related configurations are done via the API's exposed by the application configurator platform backend. The User Interface as a code (UIaC) is executed using the execution environment which is pre-configured within the platform. Screen configurations are managed by the screens APIs and provide the app admin the ability to create screens and to assign the level for each screen. The screen level signifies the type of screen which is the main screen, sub-screen, or tab. Each screen is associated with a screen index that identifies the screen uniquely in the collection of screens. The screen configuration data is organized as a list and consists of screen name, id description, level, and hidden. Each screen created consists of a unique ID that is mapped to the application based on the app ID. All the data related to screens and their configuration is stored in the app_screen table with app_id as an identifier.

In an embodiment herein, the Filter UIaC can be used to compose a wide range of following filters Hierarchical Filters, Non-Hierarchical Filters, Single Select filter & Multi-select Filters, Date Filters, and Number Range filters. Data to the filter component can be retrieved from a SQL database. Within the Filter UIaC, editor app admins can use the SQL connectors that are part of the widget factory lite module. Static filter UIaC data can also be entered in the code editor section.

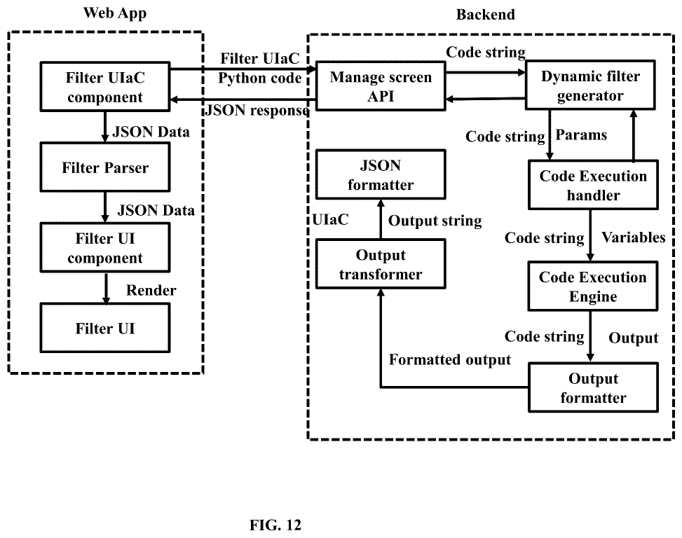

FIG. 12 is an example diagram depicting the implementation of the user interface within the platform, according to embodiments as disclosed herein. As depicted in FIG. 12, Filter UIaC component triggers an API call on passing the user interface python code in the request body. The API handler processes the request and invokes the dynamic filter function by passing the python code string. The dynamic filter function generates the dynamic filters for the specified screen_id.

In an embodiment herein, the code execution handler is used to handle the execution of the python code string. The handler de-serializes the code string and decides how to execute the UIaC depending. If the execution environment is defined, then the UIaC is executed within the defined execution environment else the code is executed internally within the backend service. The code execution engine i.e., the pre-defined execution environment or the backend runtime executes the python code.

In an embodiment herein, all the outputs from the STDOUT are captured and formatted and transformed by the data transformer. The JSON formatter functions convert the data into JSON format and are returned to the execution handler. The execution handler then returns this JSON data to the dynamic filter function which is sent to the API handler. The API handlers return the response to the web application that contains the output of the execution in JSON format. The JSON data is then parsed and rendered as UI by the filter component.

The requested data fields incorporated for Filter UIaC are mentioned below in Table 3:

TABLE 3

| Field Name | Data Type | Description |
|---|---|---|
| code_string | String | User Interface Python Code in |
| | | string format |
| screen_filters_open | Boolean | |

The response data fields incorporated for Filter UIaC are mentioned below in Table 4:

TABLE 4

| Field Name | Data Type | Description |
|---|---|---|
| Status | String | Status of the operation |
| Output | Boolean | Detailed output of execution |
| Output_datavalues | Array | Filter widget configurable output - |
| | | widget tag, label, key, etc. |
| Time taken | String | Time is taken to execute the code |
| Size | String | Size in bytes |

API Specifications incorporated for Filter UIaC are mentioned below in Table 5:

TABLE 5

| | | | Request/ | |
|---|---|---|---|---|
| | | HTTP | Response | Authorization |
| Name | Description | method | Content type | Request |
| Test or | API to execute the | POST | JSON | yes |
| Execute | Filter UIaC | | | |
| Filter | | | | |
| UIaC | | | | |

In an embodiment herein, the filters are created in python using the widget factory lite module that consists of the filter function. The python code related to the filter UIaC is passed to the filter function which generates a JSON formatted code. This JSON data is used by the web application to generate the User Interface related to Filters. The widget factory allows the user to prepare standardized code wherein modules are called that are available in the widget factory. Users can create tests and train their models.

In an embodiment herein, to deploy and serve modules, the system (200) uses an additional feature namely widget factory lite. The widget factory lite is a small package created to easily convert the data into a format that is the application configurator complaint. The widget factory lite has numerous transformational functions, classes, and methods, is used to run this compliance. The widget factory lite allows the user to quickly modify the data from the source into a format that complies with the application configurator. The widget factory lite ensures that the user is compliant with the code that the user writes, reads the data from a predefined input and output is also compliant with to predefined output.

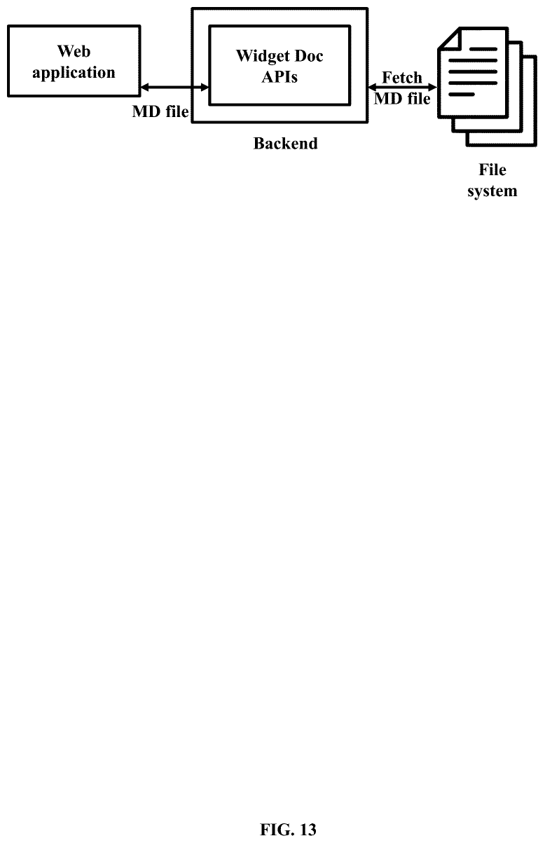

FIG. 13 is an example diagram depicting the implementation of the widget component, according to embodiments as disclosed herein. As depicted in FIG. 13, the widget factory can be implemented using the markdown format. The markdown data is converted to string and then returns as a response by the widget documentation API.

Data Fields incorporated for Widget are mentioned below in Table 6:

| Field Name | Data Type | Description |
|---|---|---|
| data | String | Markdown in String format |

The API specification for the widget is mentioned below:

TABLE 6

| | | | Request/ | Authori- |
|---|---|---|---|---|
| | | HTTP | Response | zation |
| Name | Description | Method | Content Type | required |
| Fetch Widget | Obtains the MD | GET | JSON | Yes |
| Documentation | file related to | | | |
| | the widget | | | |

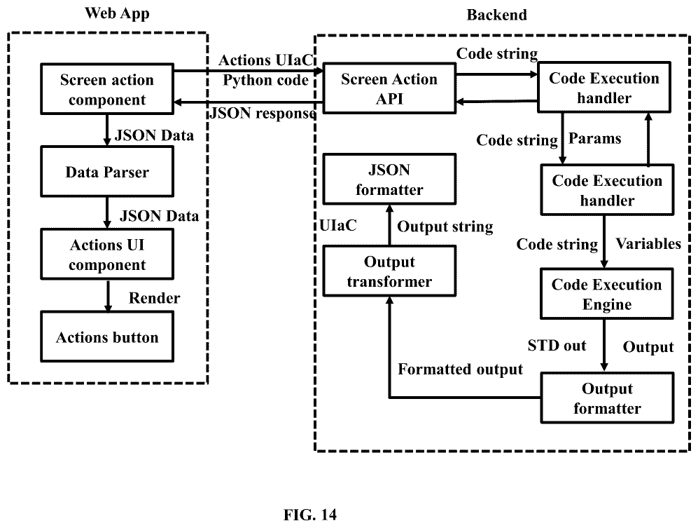

FIG. 14 is an example diagram depicting the implementation of the screen-level action within the platform, according to embodiments as disclosed herein. FIG. 14 depicts the implementation of the screen-level action within the application configurator platform backend. The requested data fields of screen-level actions are listed below in table 7:

TABLE 7

| Field Name | Data Type | Description |
|---|---|---|
| Code_string | String | User Interface Python code in |
| | | string format |

The response data field of screen-level actions is listed below in Table 8:

TABLE 8

| Field Name | Data Type | Description |
|---|---|---|
| Status | String | Status of the operation |
| Output | Object | Detailed output of execution |
| Output_actions | Array | Action buttons data |
| Timetaken | String | Time taken to execute Code |
| size | String | Size in bytes |

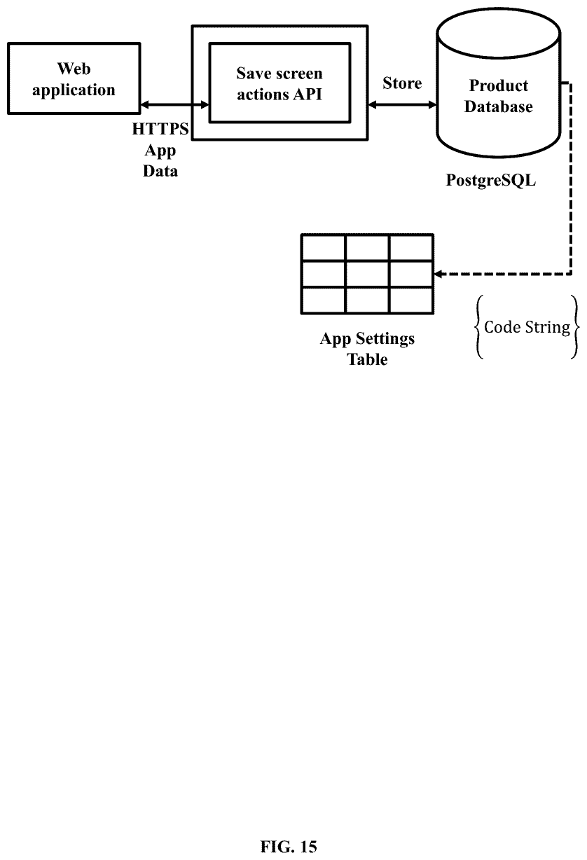

FIG. 15 is an example diagram depicting the implementation and saving of the screen-level action, according to embodiments as disclosed herein. As depicted in FIG. 15, the screen-level actions can be stored as python code in a string within the app_settings table. The application configurator provides several customizable layout selections that allow user to configure and present data in multiple formats. The layout Selection feature allows the user to select from a list of pre-defined layouts based on the number of visuals and the number of screens KPIs.

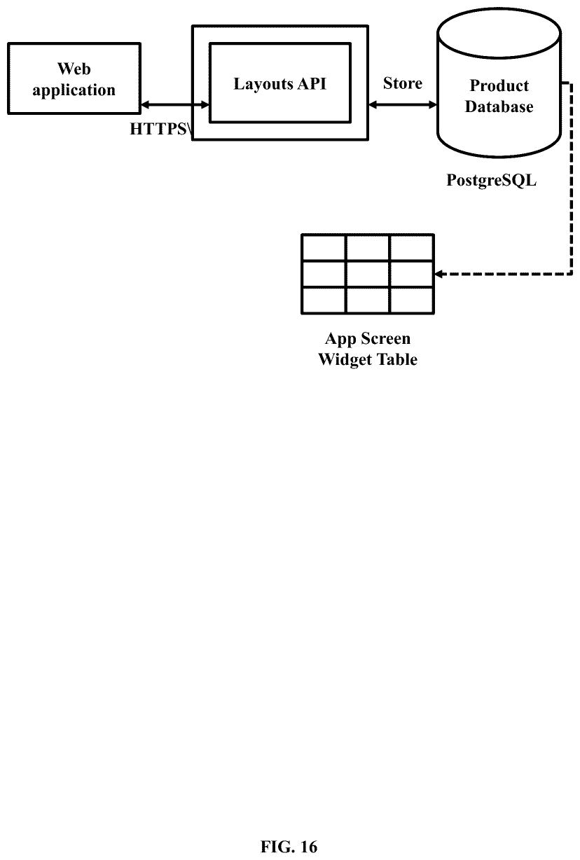

FIG. 16 is an example diagram depicting the layout selection feature, according to embodiments as disclosed herein. As depicted in FIG. 15, The Layout API accepts the screen layout in terms of several labels, graphs, and widgets based on the layout selection. Internally widgets are listed and consist of widget_index and its configuration details such as title, subtitle, metric factor, and others details. All the screen layout details are converted to a string and being stored in the App_screen_widget table. Data within the app_screen widget is identified by the app_screen_id and the app_id this determines the widgets in the particular screen of the application.

The data fields of layout selection are mentioned below in Table 9:

TABLE 9

| Field Name | Data Type | Description |
|---|---|---|
| Id | Int | Widget ID |
| Widget_key | String | |
| Widget_title | String | Title for the widget |
| Widget_subtitle | String | Subtitle for the widget |
| Metric_factor | String | Factor associated with the |
| | | metric |

API specifications for layout selection are mentioned below in Table 10:

TABLE 10

| | | | Request/ | Authori- |
|---|---|---|---|---|
| | | HTTP | Response | zation |
| Name | Description | Method | Content Type | required |
| Create Layout | Manage | POST | JSON | Yes |
| | application | | | |
| | layouts within | | | |
| | the specific | | | |
| | screen | | | |
| Get widgets | Obtain the | GET | JSON | Yes |
| | widgets for a | | | |
| | particular | | | |
| | screen | | | |

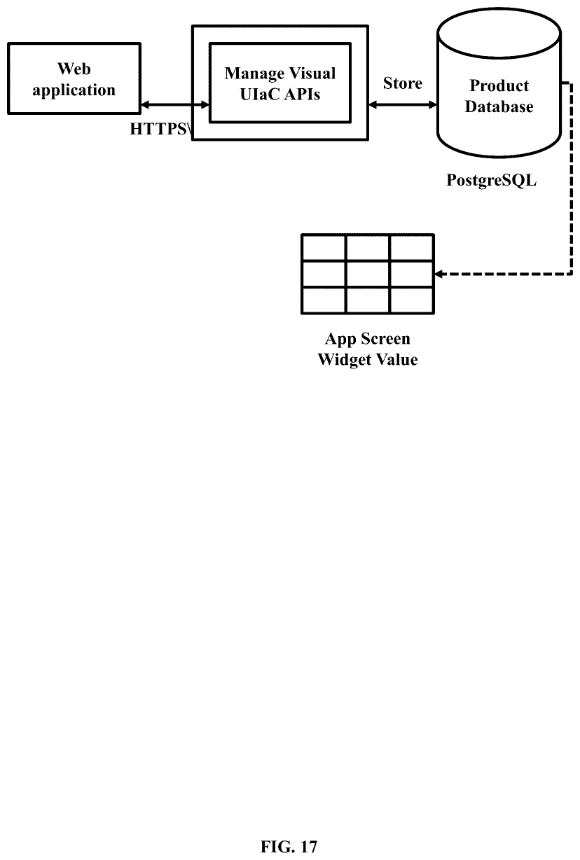

FIG. 17 is an example diagram depicting the visual user interface management, according to embodiments as disclosed herein. Visual User Interface code provides application admins with the ability to configure report widgets such as numeric metrics, graphs, or charts depending on the widget type. Data to the visual UIaC widgets can be passed from the file system (200) or can be fetched from an SQL database. Application configurator enables the user to create Visuals through UIaC (User Interface as Code). All UIaCs supports the following visual types Metrics, Plotly graph, Simple Table, Grid Table, Expandable Table, and Text Insights.

In an embodiment herein, the data for the filter component can be obtained from a SQL database. Within the Filter UIaC editor app admins can use the SQL connectors that are part of the widget factory lite module. Static filter UIaC data can also be entered in the code editor section, or the data can be passed from cloud file storage services such as Azure Blob Storage, and Amazon S3. All the data from the data sources are used by the UIaC components.

As depicted in FIG. 17, all the visual UIaC are stored as code storing within the application configurator platform database. The below diagram shows the implementation of Visual UIaC management.

Data fields incorporated for Manage Visual UIaC are mentioned below in table 11:

TABLE 11

| Field Name | Data Type | Description |
|---|---|---|
| Id | Int | Widget Value ID |
| Widget_ID | String | Widget ID |
| Widget_value | String | Contains the widget UlaC as |
| | | code string |
| Access_token | String | Access token for the widget |
| Screen_Id | String | Screen which contains the |
| | | widget code |

API specification for manage Visual UIac are mentioned below in table 12:

TABLE 12

| | | | Request/ | Authori- |
|---|---|---|---|---|
| | | HTTP | Response | zation |
| Name | Description | Method | Content Type | required |
| Create or update | Manage the | POST | JSON | Yes |
| visual Ulacs | visual Ulacs | | | |
| | code | | | |
| Get widgets | Obtain the | GET | JSON | Yes |
| | visual Ulacs for | | | |
| | a particular | | | |
| | widget of a | | | |
| | screen | | | |

FIG. 17 is an example diagram depicting the implementation of the visual user interface feature, according to embodiments as disclosed herein. As depicted in FIG. 17, the visual UIaC API accepts the python code string and the selected dynamic filter in the request body. The request payload is formatted by the request handler and is passed as input to the mapper function. The mapper function obtains the dynamic widgets using the filters, code, and state key and maps those as input to the code execution handler function. Code execution engines execute the code based on the execution environment parameters that are defined. The output from the execution engine is formatted, transformed, and converted into a JSON format. The JSON data that contains the UI configuration details utilized by the Visual component and renders the UI accordingly.

The requested data fields incorporated for Visual UIaC are mentioned below in Table 13:

TABLE 13

| Field Name | Data Type | Description |
|---|---|---|
| Code_string | String | User interface python code in |
| | | string format |
| filters | Object | Selected filter values or the |
| | | default values |

The response data fields incorporated for Visual UIaC are mentioned below in Table 14:

TABLE 14

| Field Name | Data Type | Description |
|---|---|---|
| status | String | Status of the operation |
| output | Object | Detailed output of execution |
| Output_data | Array | UI visual related data |
| | | consisting of visual |
| | | configuration details |
| Timetaken | String | Time taken to execute the |
| | | code |
| Size | String | Size in bytes |

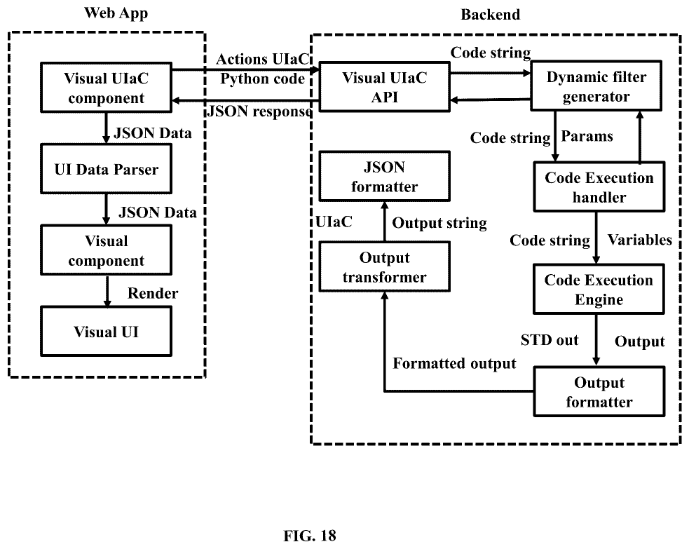

FIG. 18 is an example diagram depicting the implementation of the application replication to be created from the preview version, according to embodiments as disclosed herein. The application configurator allows user to define an application variable and value. The value of application variable is hidden. For example, application variable value will be stored in an encrypted format using SSHD 256 inside Database. The application configurator enables the storage of application variable values in a secure manner that even the system (200) administrator cannot access. Application replication features allow creating a copy of the application. This copy is used as a production version which can be accessed by the application users. Users can select the source version from where user want to copy the created version of the application.

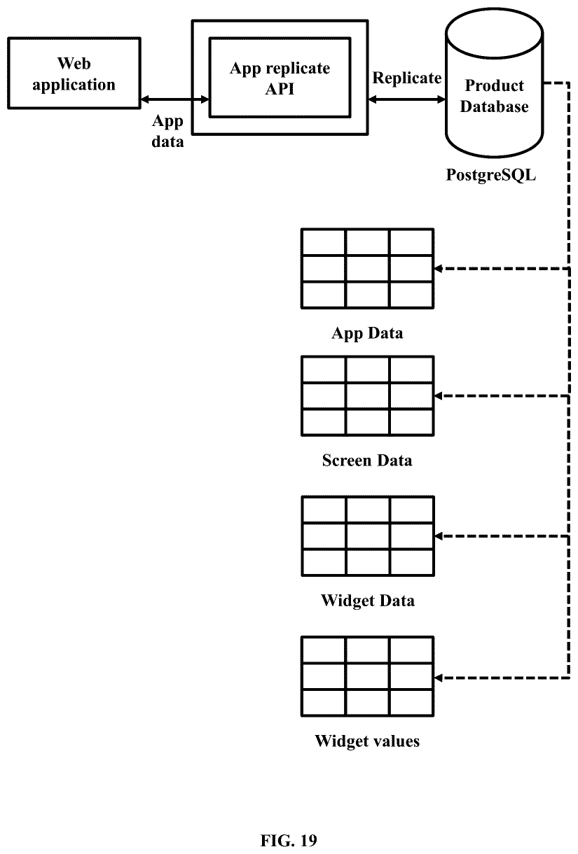

As depicted in FIG. 19, the replicate feature enables to copy of the application in the preview version into the prod version. The replication API creates an exact copy of the application and its related data across the related application, screens, and widget tables. FIG. 19 depicts the implementation of the application replication which creates the prod version of the application from the preview version.

The data fields incorporated for replicating application are mentioned below in Table 15:

TABLE 15

| Field Name | Data Type | Description |
|---|---|---|
| Source_app_id | Int | Source Application Id |
| Destination_app_env | Boolean | Detailed output of execution |
| Destination_app_id | int | App id of the replicated |
| | | environment |
| Copy_app_vars_flag | Boolean | Determine whether variables |
| | | are required to be copied |

API specifications for replicating applications are mentioned below in Table 16:

TABLE 16

| | | | Request/ | |
|---|---|---|---|---|
| | | HTTP | Response | Authorization |
| Name | Description | Method | Content Type | required |
| Replicate | Replicates the | POST | JSON | Yes |
| Application | application, | | | |
| | configuration | | | |
| | and its widgets | | | |

In an embodiment herein, upon turning OFF Copy App variable, the user will be unable to copy any application variables.

The embodiments disclosed herein have the ability to set up independent execution environments for each application which will improve user experience in terms of loading time and set the grounds for further expanding the computational capacity of the application. Cloning applications with the ability to copy an application and its contents from one environment to another. Multiuser features can enable multiple data scientists to edit applications simultaneously.

The embodiments herein allow the creation of custom data products, contextualized to the client's businesses through a large library of UI widgets. These UI widgets are powered by custom python codes, which refer to as User Interface as Code (UIaC). These UIaCs enable data scientists to build responsive, interactive, and custom UI elements through a python interface, without any prior expertise in UI development frameworks and libraries (such as HTML, CSS, JavaScript, react, etc.). Application configurator's UIaC feature in combination with its rich UI widget library help in achieving the following outcomes—

It can bridge the skillset gap that previously prevented data scientists to build interactive and responsive user interfaces, for businesses to consume data and model insights. It significantly can reduce the turnaround time in developing and deploying custom UI screens, powered by a python interface. Using UIaCs, data scientists can build custom advanced data science-driven business applications which can allow end business users to interact with the models and simulations and receive real-time insights enabling them to make quick business decisions. Application configurator can allow downstream integration as well which enables our applications to connect with other BI and Visualization tools to represent data. This can reduce the need for organization-wide technology to revamp and allow businesses to continue using existing tools and technologies which improves the adoption of insights and reduces the time to see results.

The embodiments disclosed herein can be implemented through at least one software program running on at least one hardware device and performing network management functions to control the elements. The elements shown can be at least one of a hardware device or a combination of hardware devices and software modules.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for description and not of limitation. Therefore, while the embodiments herein have been described in terms of at least one embodiment, those skilled in the art will recognize that the embodiments herein can be practiced with modification within the spirit and scope of the embodiments as described herein.

We claim:

1. An application configurator system comprising:
a processor;
a memory; wherein the processor is coupled with the memory and wherein the processor is configured to:
receive a selection input for accessing an execution environment associated with an application configurator, wherein the application configurator is a system that allows to build and test data products that are responsive, interactive, and custom user interface elements contextualized to at least one application implemented in the execution environment based a user's requirement;
cause to display an interactive functional dashboard to perform at least one function on at least one application presented in the application configurator, wherein the at least one function comprises at least one of modify interactive screen, modify layouts, modify modules, modify widgets, modify metrics and modify filters; and
manage the at least one function based on a user input.

2. The application configurator system, as claimed in claim 1 wherein:
the system is configured to allow to build and test data products without having a dependency on external tools or packages; and
there is no requirement of expertise in UI development frameworks and libraries.

3. The application configurator system, as claimed in claim 1 wherein the execution environment comprises at least one of a preview environment, a staging environment, a production environment and a testing environment.

4. The application configurator system, as claimed in claim 1 wherein:
the at least one of screens, layouts, widgets, metrics and filters are modified using a user interface as code (UIaC) and modules, and
modules enables to toggle specific one function on at least one application presented in the application configurator.

5. The application configurator system, as claimed in claim 1 wherein the application configurator is configured to allow to insert modules that enable the user to insert the configurations with specific information and no information required functions.

6. The application configurator system, as claimed in claim 1 wherein the application configurator is configured to allow to copy and modify a sample information of at least one of screens, layouts, widgets, metrics and filters are modified using a user interface as code (UIaC) in order to contextualize the at least one application implemented in the execution environment based a user's requirement.

7. The application configurator system, as claimed in claim 1 wherein:
the application configurator is configured to receive details comprising at least one of an application name, an email ID, and an industry for the at least one application implemented in the execution environment; and
the application configurator allows to:
create a new group of industries, domains and respective functions apart from predefined domains; and
store the details of the application configurator platform database.

8. The application configurator system, as claimed in claim 1 wherein the application configurator:
is configured to modify screens comprises adding, removing, previewing, and resetting, screens and sub screens at different hierarchy levels; and
allows to modify interactive screen, modify layouts, modify modules, modify widgets, modify metrics and modify filters at each level of hierarchy of the screen.

9. The application configurator system, as claimed in claim 1 wherein:
the application configurator is configured to manage at least one function comprises performing at least one of adding, removing, previewing, saving, testing and resetting the at least one of interface elements; and
the interface elements comprises at least one of the interactive screen, layouts, modules, widgets, metrics and filters.

10. The application configurator system, as claimed in claim 1 wherein the application configurator is configured to store the application configurations of the application implemented in the execution environment comprising a description, a problem area, an execution environment, a login, and application logos in the application configurator metadata database.

11. The application configurator system, as claimed in claim 1 wherein at least one of hierarchical filters, non-hierarchical filters, single select filter, multi-select filters, date filters, and number range filters are composed using a filter UIaC.

12. The application configurator system, as claimed in claim 1 wherein the application configurator configures report widgets comprising at least one of numeric metrics, graphs, and charts depending on the widget type.

13. The application configurator system, as claimed in claim 1 wherein the UIaCs may support at least one of visual types metrics, a plotly graph, a simple table, a grid table, expandable table, and text insights.

14. A method comprising:
receiving a selection input for accessing an execution environment associated with an application configurator, wherein the application configurator is a system that allows to build and test data products that are responsive, interactive, and custom user interface elements contextualized to at least one application implemented in the execution environment based a user's requirement;
causing to display an interactive functional dashboard to perform at least one function on at least one application presented in the application configurator, wherein the at least one function comprises at least one of modify interactive screen, modify layouts, modify modules, modify widgets, modify metrics and modify filters; and
managing the at least one function based on a user input.

15. The method, as claimed in claim 14, further comprising:
inserting modules that enable the user to insert the configurations with specific information and no information required functions.

16. The method, as claimed in claim 14, further comprising:
copying and modifying a sample information of at least one of screens, layouts, widgets, metrics and filters are modified using a user interface as code (UIaC) in order to contextualize the at least one application implemented in the execution environment based a user's requirement.

17. The method, as claimed in claim 14, further comprising:
receiving details comprising at least one of an application name, an email ID, and an industry for the at least one application implemented in the execution industries, domains and respective functions apart from predefined domains; and
storing the details of the application configurator platform database.

18. The method, as claimed in claim 14, further comprising:
modifying screens comprises adding, removing, previewing, and resetting, screens and sub screens at different hierarchy levels; and
modifying interactive screen, modify layouts, modify modules, modify widgets, modify metrics and modify filters at each level of hierarchy of the screen.

19. The method, as claimed in claim 14, further comprising:
performing at least one of adding, removing, previewing, saving, testing and resetting the at least one of interface elements, wherein the interface elements comprises at least one of the interactive screen, layouts, modules, widgets, metrics and filters.

20. The method, as claimed in claim 14, further comprising:
storing the application configurations of the application implemented in the execution environment comprising a description, a problem area, an execution environment, a login, and application logos in the application configurator metadata database.

21. The method, as claimed in claim 14, further comprising:
composing at least one of hierarchical filters, non-hierarchical filters, single select filter, multi-select filters, date filters, and number range filters using a filter UIaC.

22. The method, as claimed in claim 14, further comprising:
configuring report widgets comprising at least one of numeric metrics, graphs, and charts depending on the widget type.
